(19) United States
(12) Patent Application Publication
(10) Pub. No.: US 2004/0140299 A1
(43) Pub. Date: Jul. 22, 2004

(54) Laser drilling method

(75) Inventors: Kunio Arai, Ebina (JP); Yasuhiko Kita, Ebina (JP)

Correspondence Address: CROWELL & MORING LLP, INTELLECTUAL PROPERTY GROUP, P.O. BOX 14300, WASHINGTON, DC, 20044-4300, US

(73) Assignee: HITACHI VIA MECHANICS, LTD., EBINA-SHI (JP)

(21) Appl. No.: 10/753,350

(22) Filed: Jan. 9, 2004

(30) Foreign Application Priority Data
Jan. 9, 2003 (JP) 2003-003365

(51) Int. Cl. B23K 26/38

(52) U.S. Cl. 219/121.71

(57) ABSTRACT

There is provided a laser drilling method including the step of successively drilling toward an inner part of a machining area while circumferentially moving beam positions from the outer periphery of the machining area. This causes thermal deformation to be symmetric with respect to the center of the machining area, and tension to be applied to the inner part, thereby preventing bending to increase the hole positioning accuracy.

### FIELD OF THE INVENTION

The present invention relates to a laser drilling method of a printed circuit board.

### BACKGROUND OF THE INVENTION

Printed circuit boards widely used as boards of personal computers and mobile phones have increasingly become more compact and been highly integrated, and a pitch of holes drilled in a board has rapidly become smaller and the number of holes has increased.

FIG. 3 shows a beam positioning mechanism of a laser machining device. Reference numeral 1 denotes a laser oscillator; 2, a laser beam; 3, a corner mirror; 4, a galvanometer mirror for positioning in an X direction; 5, a galvanometer mirror for positioning in a Y direction; 6, an fθ lens; 7, a machining area; 8, a controller; 10, a board to be machined; 11, a collimator lens system; 12, an aperture; and 13, a corner mirror. The laser beam 2 is positioned in the machining area 7 by the galvanometer mirrors 3 and 4 and the fθ lens 5, which are controlled by the controller 8, for drilling. The size of the machining area is fθ×fθ, where θ is a maximum oscillation angle (radian) of the galvanometer mirrors 3 and 4, and f is a focal length of the fθ lens 5. A predetermined number of holes are provided on a grid-like pattern with predetermined intervals in the machining area 7.

In conventional laser drilling of a printed circuit board, as shown in FIGS. 4 and 5, machining is performed by linear reciprocating movement (FIG. 4) in the following order: H₁, H₂, H₃, H₄ . . . or zigzag reciprocating movement (FIG. 5) from a corner of an outermost periphery of a machining area, so as to minimize a movement distance.

Laser machining causes primary or secondary heat production to decompose and remove a material. At this time, most of heat produced by machining is carried away by the decomposed material, but part of the heat increases the temperature of a base material around holes by heat conduction. Further, spatial distribution of energy of a laser has always a tailed profile even if shaped into a rectangle-like (a top hat shape), and has the first order peak, the second order etc. peak by diffraction, thus directly increasing the temperature around the holes. Therefore, the temperature of the material around the holes gradually increases as the machining proceeds, and thus the board is machined while expanding irregularly. In particular, a thick material requires a larger number of pulses, that is, higher input energy, and thus the temperature increases significantly. This causes a problem in the conventional drilling method that even if positioning accuracy by the galvanometer mirror is ±5 μm or less, hole positioning accuracy changes between a machining start position and a machining finish position, and becomes ±20 μm or more when the machining area is wide (about 50 mm in width).

This problem is more noticeable when the board to be machined is made of a material having a high thermal expansion coefficient such as an organic material or a green sheet.

As disclosed in JP-A-2001-79677, a method for drilling in an alternate manner or a method for drilling in a random manner is known as a method for reducing the influence of thermal expansion.

However, such a method is essentially no different from the related art (FIGS. 4 and 5), and does not solve the problem.

### SUMMARY OF THE INVENTION

The invention has an object to provide a laser drilling method that can reduce the influence of thermal expansion.

Specifically, a laser drilling method for drilling a board made of a material having a positive linear expansion coefficient at room temperature is preferably used, wherein the method includes the step of successively drilling toward an inner part of a machining area while circumferentially moving a beam position from the outer periphery of the machining area.

Further, a laser drilling method for drilling a board made of a material having a negative linear expansion coefficient at room temperature such as aramid is preferably used, wherein the method includes the step of successively drilling toward an outer periphery of a machining area while circumferentially moving a beam position from a center of the machining area.

Thermal deformation during the machining occurs symmetrically with respect to the center of the machining area, and tension is applied to the inner part, thereby preventing bending and reducing distortion to increase hole positioning accuracy.

With correcting the expansion, the angular distortion, and the central shift of the distribution based on results of a test sample, the hole positioning accuracy increases further.

A laser drilling method for drilling a board made of a material having a positive linear expansion coefficient at room temperature is preferably used, wherein the method includes the step of drilling by dividing a machining area into circular portions, circumferentially moving beam positions one turn along the outermost periphery of the outermost divided portion, then step moving the beam position to the outermost periphery of the inner adjacent divided portion for one turn, successively step moving the beam position to the outermost periphery of the inner divided portion for one turn, and after circumferentially moving the beam positions one turn along the outermost periphery of the innermost divided portion, step moving the beam position to the next outer periphery of the outermost divided portion for one turn, and thereafter repeating the same.

On the other hand, a laser drilling method for drilling a board made of a material having a negative linear expansion coefficient at room temperature is preferably used, wherein the method includes the step of drilling by dividing a machining area into circular portions, circumferentially moving beam positions one turn along the innermost portion of the innermost divided portion, then step moving the beam position to the innermost periphery of the outer adjacent divided portion for one turn, successively step moving the beam position to the innermost periphery of the outer divided portion for one turn, and after circumferentially moving the beam position one turn along the innermost periphery of the outermost divided portion, step moving the beam position to the next inner periphery of the innermost divided portion for one turn, and thereafter repeating the same.

Thermal deformation in the machining area can be made uniform and reduced to increase hole positioning accuracy.

Therefore, according to the invention, the hole positioning accuracy of ±15 μm or less can be obtained in a machining area of 50 mm×50 mm.

Further, according to the invention, correcting the expansion, the angular distortion, and the central shift of the distribution depending on the width of the machining area ensures high hole positioning accuracy in the entire machining area.

### BRIEF DESCRIPTION OF THE DRAWINGS

FIG. 1 is a view of a first drilling method according to the invention;

FIG. 2 is a view of a second drilling method according to the invention;

FIG. 3 is a view of an optical system configuration of a laser machining device;

FIG. 4 is a view of a conventional drilling method; and

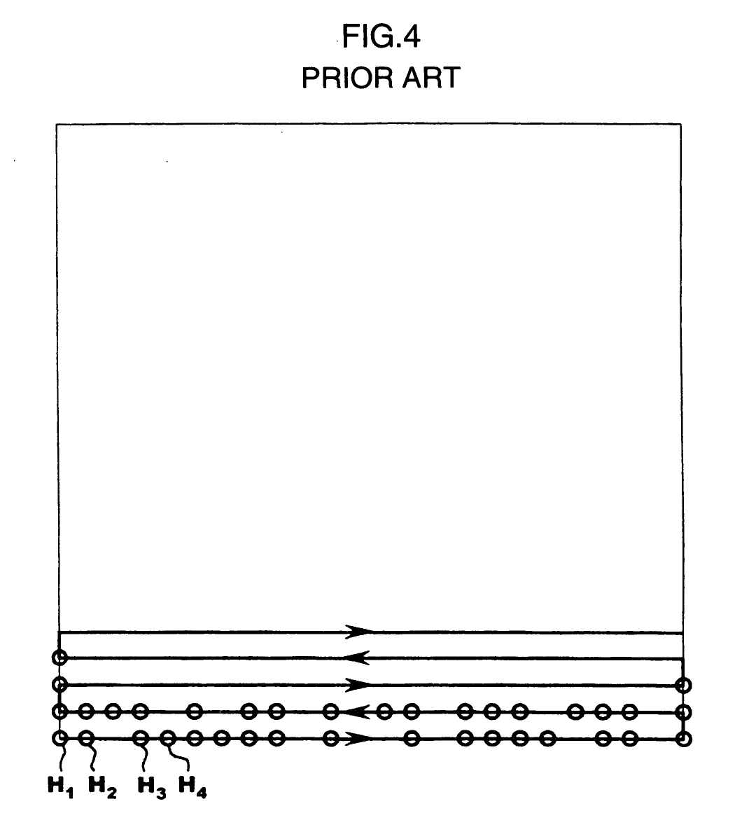

FIG. 5 is a view of another conventional drilling method.

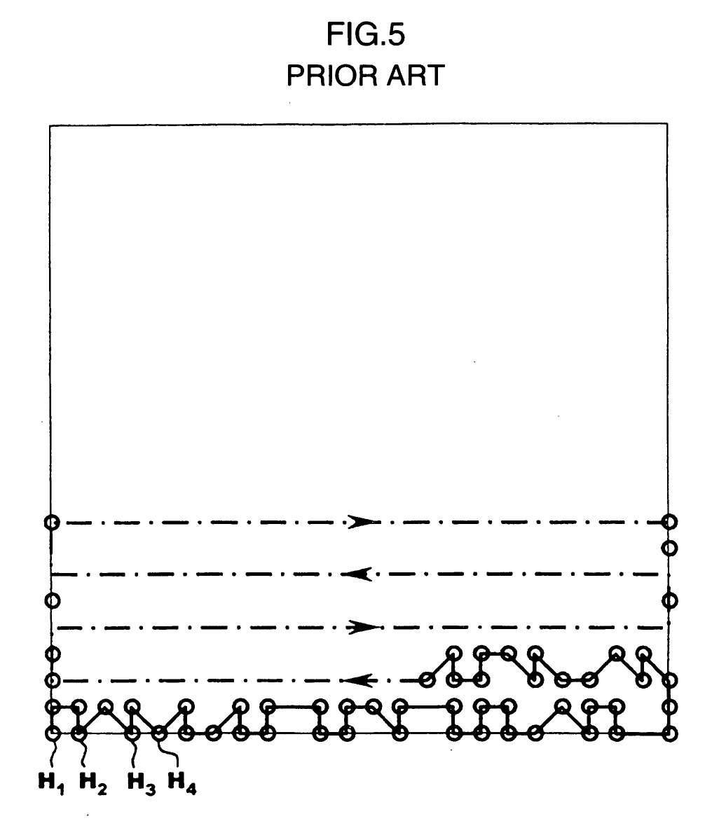

### DETAILED DESCRIPTION OF THE INVENTION

Embodiments of the invention will be described with reference to the drawings.

<Embodiment 1>

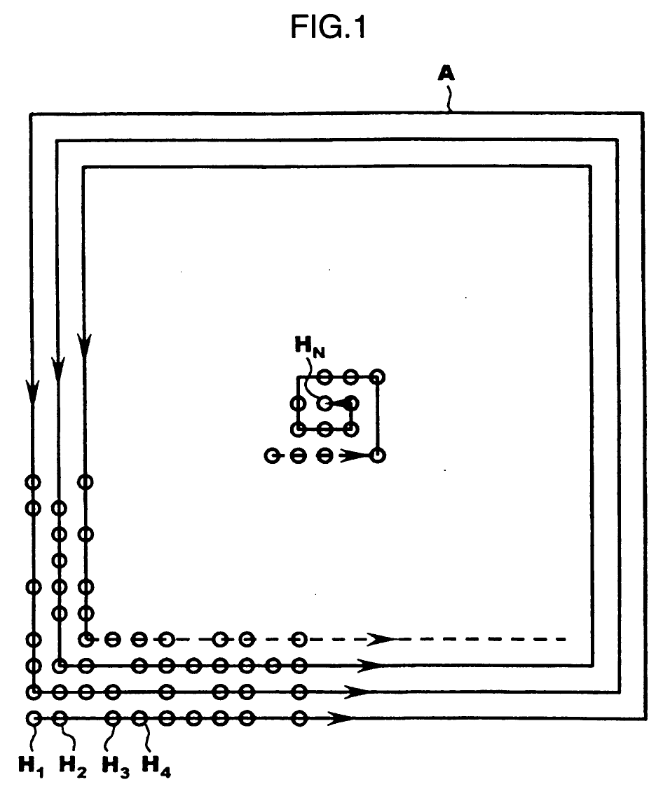

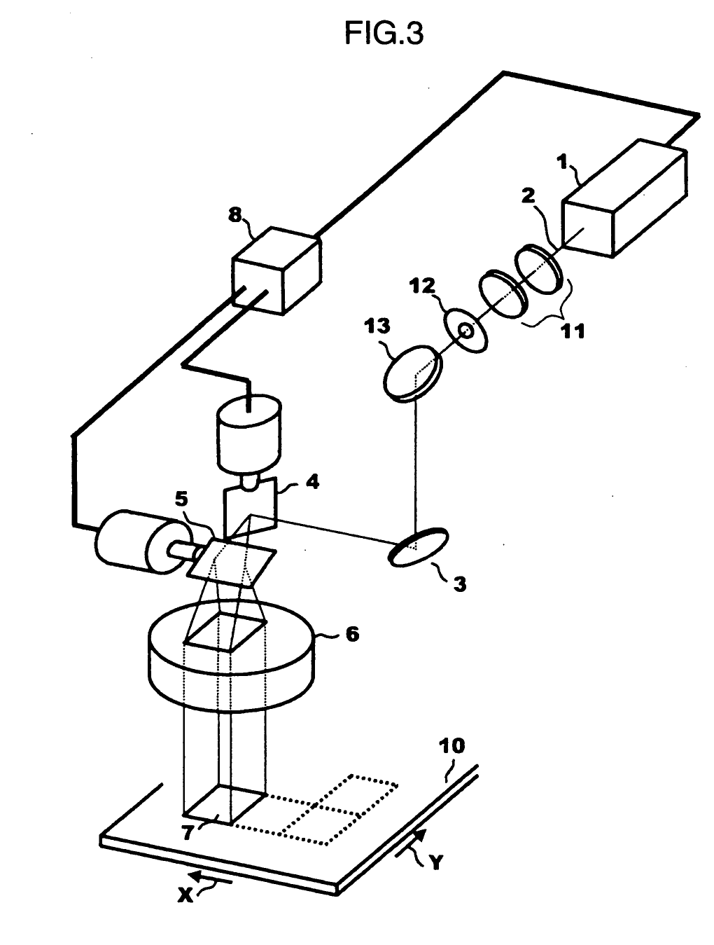

FIG. 1 is a view of a first laser drilling method according to the invention. In FIG. 1, reference character A denotes an outer periphery of a machining area 7 in FIG. 3, and reference characters H₁, H₂, H₃ . . . H_{N} denote holes distributed in the machining area 7. When the holes H₁, H₂, H₃ . . . H_{N} are to be machined, drilling is started at H₁ in the outer periphery A, beams are circumferentially positioned in the following order: H₁, H₂, H₃ . . . H_{N} and the circumferential movement position is shifted from the outer periphery toward the inner periphery in a radial direction of circumferential movement for machining, and the machining is finished at H_{N}.

When this machining method was applied to drilling of a 300 μm thick green sheet, hole positioning accuracy was ±12 μm. Herein, the machining area was 50 mm×50 mm, the laser used was a CO₂ laser, the energy was 40 mJ per hole, the diameter of the holes was 120 μm, the hole pitch was 1 mm, and the machining speed was 200 holes per second.

When the above described sample was used as a test sample, and based on machining data of the sample, the expansion, the angular distortion, and the central shift of the distribution were calculated and corrected for machining, the hole positioning accuracy became ±7 μm. This is substantially equal to the positioning accuracy by the galvanometer mirrors.

<Embodiment 2>

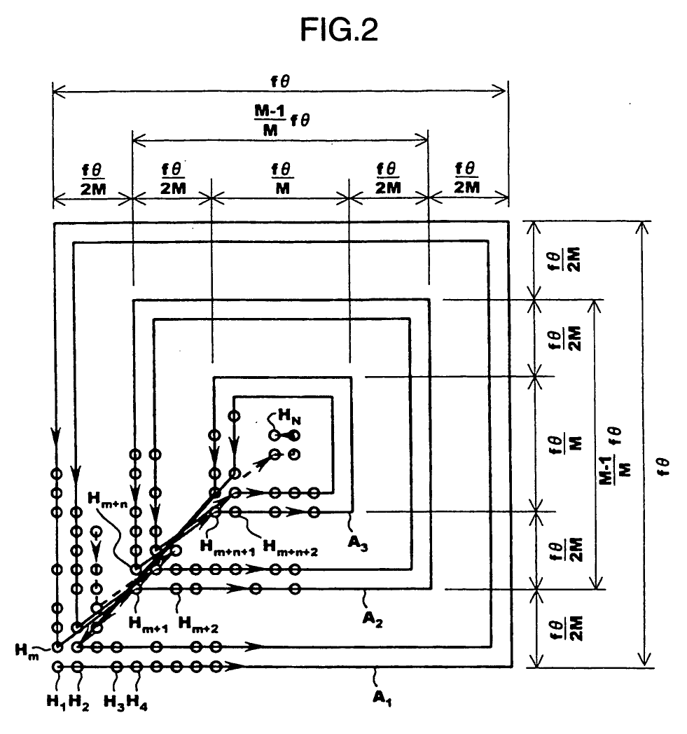

FIG. 2 is a view of a second laser drilling method according to the invention. FIG. 2 shows an example where a machining area fθ is divided into geometrically similar M parts (herein M=3) so as to be substantially equidistant in radial directions of circumferential movement and concentric. Herein, reference character A₁ denotes a range of fθ/2M from a machining side length fθ of the first machining area, and reference characters H₁, H₂, H₃ . . . Hₘ denote holes distributed in the machining area A₁. A reference character A₂ denotes a range of fθ/2M from a machining side length fθ(M−1)/M of the second machining area, and reference characters Hₘ₊₁, Hₘ₊₂, Hₘ₊₃ . . . Hₘ₊ₙ denote holes distributed in the machining area A₂. A reference character A₃ denotes a range of fθ/2M from a machining side lengths fθ(M−2)/M of the third machining area, and reference characters Hₘ₊ₙ₊₁, Hₘ₊ₙ₊₂, Hₘ₊ₙ₊₃ . . . denote holes distributed in the machining area A₃. A reference character A_{M} denotes a machining side length fθ/M of an M-th machining area, and reference characters . . . H_{N-1}, H_{N} denote holes distributed in the machining area A_{M}. The holes in the machining areas A₁ to A_{M} correspond to any of the holes H₁, H₂, H₃ . . . H_{N} in FIG. 1.

Drilling is performed by the following procedure. First, the beam machining trajectory is circumferentially moved along the outermost periphery of each of the first machining area A₁, the second machining area A₂ . . . and the M-th machining area A_{M} in this order for drilling. Movement between the machining areas A₁-A₂, A₂-A₃ . . . is performed by step movement from a one-turn machining finish position Hₘ, Hₘ₊ₙ . . . of each area to a machining start position Hₘ₊₁, Hₘ₊ₙ₊₁ . . . of a next area.

Specifically, the beam machining trajectory is moved to the outer periphery of the first machining area A₁, and circumferentially moved one turn for machining the holes in the following order: H₁, H₂, H₃ . . . . Then, the beam is moved to the outer periphery of the second machining area A₂, and circumferentially moved one turn for machining the holes in the following order: Hₘ₊₁, Hₘ₊₂, Hₘ₊₃ . . . . Similarly, the beam machining trajectory is moved to the outer periphery of the third machining area A₃, and circumferentially moved one turn for machining the holes in the following order: Hₘ₊ₙ₊₁, Hₘ₊ₙ₊₂, Hₘ₊ₙ₊₃ . . . . After these steps are successively repeated, the M-th machining area A_{M} is machined, and then the first circumferential machining is finished.

After the first circumferential machining is finished, circumferential machining of holes in the next outer periphery of each of the machining area A₁, the machining area A₂, . . . the machining area A_{M} is performed in this order, and then the second circumferential machining is finished. After these steps are successively repeated, the hole H_{N} in the machining area A_{M} is machined, and then the machining of the entire area is finished.

When this machining method was applied to drilling of a 300 μm thick green sheet, hole positioning accuracy was ±10 μm. Herein, the machining area was 50 mm×50 mm, the laser used was a CO₂ laser, the energy was 40 mJ per hole, the diameter of the holes was 120 μm, the hole pitch was 1 mm, and the machining speed was 200 holes per second.

When the above described sample was used as a test sample, and based on machining data of the sample, the expansion, the angular distortion, and the central shift of the distribution were calculated and corrected for machining, the hole positioning accuracy became ±6 μm. This is substantially equal to the positioning accuracy by the galvanometer mirrors.

Drilling a board made of a material having a negative linear expansion coefficient at room temperature such as aramid is preferably performed by reversing the procedure for a material having a positive linear expansion coefficient as described above, and by successively drilling toward the outer periphery of the machining area while circumferentially moving the beam positions from the center of the machining area, or by dividing the machining area into circular portions, circumferentially moving the beam positions one turn along the innermost periphery of the innermost divided portion, then step moving the beam position to the innermost periphery of the outer adjacent divided portion for one turn, successively step moving the beam position to the innermost periphery of the outer divided portion for one turn, and after circumferentially moving the beam position one turn along the innermost periphery of the outermost divided portion, step moving the beam position to the next inner periphery of the innermost divided portion for one turn, and thereafter repeating the same.

What is claimed is:

1. A laser drilling method for drilling a board made of a material having a positive linear expansion coefficient at room temperature, comprising the step of successively drilling toward an inner part of a machining area while circumferentially moving beam positions from the outer periphery of the machining area.

2. A laser drilling method for drilling a board made of a material having a positive linear expansion coefficient at room temperature, comprising the step of drilling by dividing a machining area into circular portions, circumferentially moving beam positions one turn along the outermost periphery of the outermost divided portion, then step moving the beam position to the outermost periphery of the inner adjacent divided portion for one turn, successively step moving the beam position to the outermost periphery of the inner divided portion for one turn, and after circumferentially moving the beam positions one turn along the outermost periphery of the innermost divided portion, step moving the beam position to the next outer periphery of the outermost divided portion for one turn, and thereafter repeating the same.

3. A laser drilling method for drilling a board made of a material having a negative linear expansion coefficient at room temperature, comprising the step of successively drilling toward the outer periphery of a machining area while circumferentially moving beam positions from the center of the machining area.

4. A laser drilling method for drilling a board made of a material having a negative linear expansion coefficient at room temperature, comprising the step of drilling by dividing a machining area into circular portions, circumferentially moving beam positions one turn along the innermost part of the innermost divided portion, then step moving the beam position to the innermost periphery of the outer adjacent divided portion for one turn, successively step moving the beam position to the innermost periphery of the outer divided portion for one turn, and after circumferentially moving the beam positions one turn along the innermost periphery of the outermost divided portion, step moving the beam position to the next inner periphery of the innermost divided portion for one turn, and thereafter repeating the same.

5. The laser drilling method according to any one of claims 1 to 4, wherein the expansion, the angular distortion, and the central shift of distribution are corrected based on results of a test sample.
